(19) United States
(12) Patent Application Publication
(10) Pub. No.: US 2019/0185976 A1
(43) Pub. Date: Jun. 20, 2019

(54) Steel Material That is Produced via Powder Metallurgy, Method for Producing a Component from Such a Steel Material and Component Produced from the Steel Material

(71) Applicant: Deutsche Edelstahlwerke Specialty Steel GmbH & Co. KG, Witten (DE)

(72) Inventors: Horst Hill, Grefrath (DE); André van Bennekom, Ainring (DE)

(21) Appl. No.: 16/330,162

(22) PCT Filed: Sep. 25, 2017
(86) PCT No.: PCT/EP2017/074202

§ 371 Date: Mar. 4, 2019

(30) Foreign Application Priority Data
Nov. 22, 2016 (EP) 16200062.4

(51) Int. Cl. C22C 38/36; B22F 1/00; B22F 3/15; B22F 3/24; C22C 38/22; C22C 38/24; C22C 38/04; C22C 38/02; B33Y 80/00; C22C 33/02

(52) U.S. Cl. CPC C22C 38/36; B22F 1/0011; B22F 3/15; B22F 3/24; C22C 38/22; C22C 38/24; B22F 2003/248; C22C 38/02; B33Y 80/00; C22C 33/0292; B22F 2304/10; B22F 2301/35; B22F 2003/247; C22C 38/04

(57) ABSTRACT

A steel material produced via powder metallurgy having a matrix that includes (in wt %) C: 3.9-5.0%, Si: 0.3-2.0%, Mn: 0.3-2.0%, P: 0-<0.035%. S: 0-<0.35%, N: 0-<0.12%. Cr: 11.0-15.0%, Mo: 0.5-2.0%, V: 13.5-16.5%. optionally at lease one element from the group of Nb, Ni, Co, and W, wherein the content of each of Ni, Co, and W is at most 1.0% and the content of Nb is at most 2.0% with the remainder being iron and unavoidable impurities. Hard material panicles may be present in contents of up to 30 wt % in the matrix. A solid semi-finished product is formed by a sintering process or an additive process from a sled alloy powder having this composition that undergoes a heal treatment and is then finished to form component.

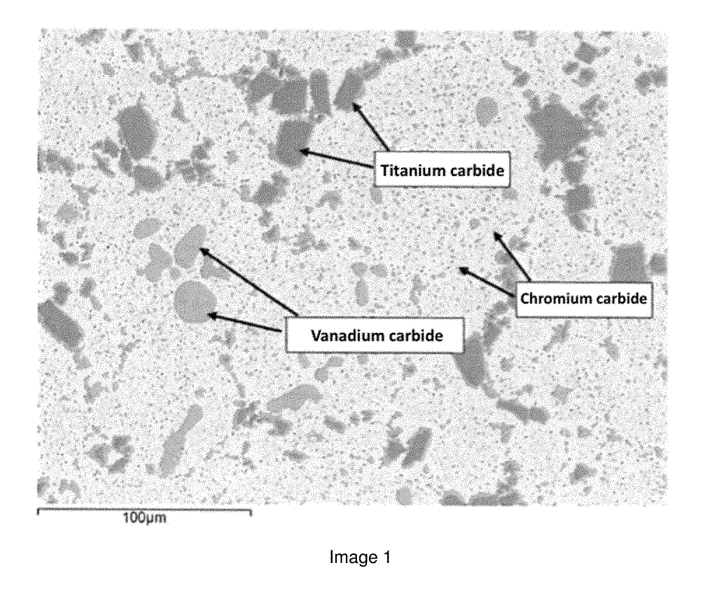

The invention relates to a steel material that is produced via powder metallurgy.

The invention also relates to a method for producing such a steel material.

Lastly, the invention also relates to components that are produced from a steel material of the type according to the invention.

The invention is particularly aimed at a steel material that is suitable for producing components that are subjected to the highest surface stresses during practical use and are moved quickly at the same time. Examples of such components are rolling guide rollers that are used in machines for wire rolling. The wire to be rolled and moved at a high conveying speed is guided on these rollers in the hot state at temperatures of more than 1000° C. Owing to its high temperature, a scale layer is formed on the wire. In addition to the high temperature and the high dynamic stresses to which they are subjected owing to their high rotational speeds associated with the high conveying speed of the wire, the rolling guide rollers are thus also subjected to high abrasive stresses on their surfaces that come into contact with the wire.

In order that they can withstand this set of stresses, high requirements are placed on the wear resistance, in particular the resistance to abrasive wear, corrosion resistance, resistance to thermal shock stress and weight of steels from which rolling guide rollers and other components that are stressed in a comparable manner during practical use are produced.

Different tests are known for meeting this requirement profile. A wear and corrosion-resistant, powder-metallurgical tool steel is described in EP 0 773 305 B1 that is intended for producing components used to process reinforced plastics and other abrasive and corrosive materials. The steel has, in addition to iron (in wt %) an Mn content of 0.2-2.0%, a P content of max. 0.1%, an S content of max. 0.1%, an Si content of max. 2.0%, a Cr content of 11.5-14.5%, an Mo content of max. 3.0%, a V content of 8.0-15.0%, an N content of 0.03-0.46% and a C content that should be 1.47-3.77%. The C, Cr, Mo, V and N contents are linked to one another by two formulae such that, on the one hand, the formation of ferrite in the structure of the component made from the steel is avoided and, on the other hand, in order to prevent the formation of excessive quantities of residual austenite during the heat treatment that the component undergoes in the course of its production. An optimal combination of metal-wear, abrasion and corrosion resistance should also be obtained by the composition determined by the formulae.

Another group of steel materials produced via powder metallurgy for the production of components of the type in question here is for example described in U.S. Pat. No. 4,249,945 A. These steels, in a preferred embodiment, have a steel matrix that consists of 0.1-1 wt % Mn, up to 2 wt % Si, 4.5-5.5 wt % Cr, 0.8-1.7 wt % Mo, up to 0.14 wt % S, 8-10.5 wt % V, 2.2-2.6 wt % C, residual iron and unavoidable impurities, and contain 13.3-17.3 vol % vanadium carbides. The steel reaches a hardness of up to 63 HRC.

Against the background of the prior art explained above, the object was to provide a steel material that provides a further optimised combination of properties for the production of components that are subjected to high mechanical, corrosive, thermal and abrasive stresses during practical use.

A method for producing components from such a steel is also mentioned.

Lastly, the aim was to indicate components for whose production the steel according to the invention is particularly suitable.

In relation to the steel, the invention has achieved this object with the steel obtained according to claim 1.

The solution according to the invention of the object set above in relation to the method consists of at least the work steps mentioned in claim 12 being carried out when producing components made from a steel according to the invention.

Lastly, the steel according to the invention is particularly suitable for producing components that perform movements at high acceleration or speed during practical use and in doing so are subjected in particular to high surface and temperature stresses. Examples of such components are rolling guides for machines for wire production, but also other tools and other components for which not only high strength during mechanical stress and wear resistance are required, but also optimal behaviour under the effect of high dynamic forces. Typical examples of this are piston pins and plunger rods.

Advantageous embodiments of the invention are indicated in the dependent claims and are explained below in detail, as is the general inventive concept.

The steel material according to the invention is produced via powder metallurgy and has the following composition (in wt %):

| | |
|---|---|
| C: | 3.9-5.0%, |
| Si: | 0.3-2.0% |
| Mn: | 0.3-2.0% |
| P: | 0-<0.035% |
| S: | 0-<0.35% |
| N: | 0-<0.12% |
| Cr: | 11.0-15.0% |
| Mo: | 0.5-2.0% |
| V: | 13.5-16.5% |

optionally one element or a plurality of elements from the group “Nb, Ni, Co, W”, wherein the content of elements “Ni, Co, W” is respectively at most 1.0% and the content of Nb is at most 2.0%, and residue consisting of iron and unavoidable impurities.

Hard material particles may optionally be present in contents of up to 30 wt % in order to maximise the mechanical properties in the steel matrix composed in this case in the manner according to the invention indicated above.

The hard material particles concerned may in particular be titanium carbide particles.

The steel according to the invention is composed such that, with a minimised density, it has a maximised resistance to extreme temperature change and also optimised corrosion resistance in addition to good wear resistance and consequently a long useful life.

When information is given in the present text on alloy contents of steels and steel materials, they refer to the weight, unless otherwise expressly indicated.

In the steel material according to the invention, the contents of C, Cr and V are in particular combined with one another such that an optimised hardness and consequently maximised strength and wear resistance is achieved.

Carbon is present in the steel according to the invention in contents of 3.9-5.0 wt % in order to enable the formation of hard, wear-resistant carbides with vanadium, chromium and molybdenum also present in the steel and in order to increase, by martensite formation, the hardness of the metal matrix in the base matrix of the structure of a component formed from the steel according to the invention. In order to achieve these effects, at least 3.9 wt % C is required. The positive effect of carbon in the steel according to the invention can be particularly safely utilised when at least 4.2 wt % C is present. With C contents of more than 5.0 wt %, the corrosion resistance can deteriorate significantly. This can be particularly safely prevented by the C content being limited to at most 4.6 wt %. Furthermore, a C content significantly above 5 wt % can also denote the stabilising of residual austenite following hardening. These phases are significantly softer than the martensite, whereby the wear resistance is also reduced. The C content of a steel according to the invention that is particularly suitable for the purposes according to the invention, is thus at most 4.5 wt %.

Silicon is, on the one hand, used for deoxidation when melting the primary materials, which are part of the steel alloy powder alloyed according to the invention and provided for producing components according to the invention. The carbon activity is also increased through the presence of silicon and thus leads to a reduction of the melting temperature. Higher C contents would be necessary without the selective addition of at least 0.3 wt % Si, in particular at least 0.7 wt % Si. The atomisation process is in turn facilitated by the reduced melting point. Silicon also reduces the viscosity of the metal melt, which also contributes to simplifying the atomisation process. At the same time, silicon increases the hardenability of the steel material since the conversion noses in the TTT diagram are shifted to longer times. The strength of the austenite at hardening temperature is increased by the dissolved proportion of Si, whereby the higher stability of the austenite can be explained and longer cooling durations enabled. These effects are achieved with Si contents of up to 2.0 wt %, in particular up to 1.5 wt %. Excessive contents of Si would lead to stabilisation of the ferrite, whereby the proportion of martensite present after hardening in the structure of the steel would be reduced and the hardness and wear resistance of the steel material according to the invention would thus also decrease.

Manganese is present in the steel material according to the invention in order to optimise the atomising capacity of the steel during production of the steel powder and its hardness. The melting point of the steel is thus reduced by the presence of sufficient contents of Mn like it is by the presence of Si and the viscosity of the metal melt is reduced such that the selective addition of Mn contributes to simplifying the atomisation process as well. At the same time, manganese also increases the hardenability of the steel material. The dissolved proportion of Mn also contributes to stabilising the austenite. Mn also binds sulphur by forming MnS, whereby the danger of hot cracks is reduced and the machinability is improved. These effects are achieved in an operationally safe manner with Mn contents of at least 0.3 wt %, in particular at least 0.7 wt % and Mn contents of up to 2.0 wt %, in particular up to 1.5 wt %. Excessive contents of manganese could, on the one hand, stabilise the austenite phase to the extent that the soft annealing duration would be significantly increased. On the other hand, the austenite phase could also be stabilised by excessive Mn contents to the extent that residual austenite remains in the structure after hardening. This microstructure would be significantly softer than martensite, whereby the hardness and wear resistance would decrease. Mn contents of a steel material according to the invention of roughly 1.2 wt % prove to be particularly practical.

Chromium serves in the steel according to the invention in combination with Mo and V to set the desired high temper resistance, corrosion resistance and hardenability. To this end, at least 11.0 wt % Cr, in particular at least 12.0 wt % are provided in the steel material according to the invention, the advantageous effects of Cr being able to be utilised in a particularly operationally safe manner by the Cr content being set to at least 12.5 wt %. Excessive Cr contents would cause more Cr carbides to form. However, C would be bound through the formation of Cr carbides, whereby the martensite formation would be reduced such that the desired high hardness of the martensite could no longer be achieved. In the case of Cr contents increased significantly beyond the upper limit predefined according to the invention, the ferritic phase would also be stabilised, whereby the required hardness and wear resistance would also not be achieved. The maximum content of Cr is thus limited to 15.0 wt %, in particular at most 14.0 wt % according to the invention, wherein Cr contents of up to 13.5 wt % have been found to be particularly suitable in practice. The Cr content of a steel material according to the invention that is particularly suitable for the purposes according to the invention is accordingly in the range of 13.0 wt %.

Molybdenum, like chromium, increases the corrosion resistance, hardenability and temper resistance of components produced from steel according to the invention when Mo contents of at least 0.5 wt %, in particular at least 0.9 wt % are present. Excessive contents of Mo would, however, also stabilise the ferritic phase. The highest content of Mo is thus limited in the steel according to the invention to 2.0 wt %, in particular max. 1.5 wt %. The Mo content of a steel according to the invention that is particularly suitable for the purposes according to the invention is accordingly preferably in the range of 1.2 wt %.

Vanadium is present in the steel according to the invention in contents of 13.5 wt % to 16.5 wt % in order to achieve an optimised wear resistance by forming large quantities of vanadium-rich carbides or carbonitrides. Vanadium is also increasingly involved in the formation of carbides when tempering in the secondary hardening maximum. Optimal effects of the presence of V can be achieved by at least 14.5 wt % V being present in the steel according to the invention. By limiting the V content to 16.5 wt %, in particular at most 16.0 wt % or at most 15.5 wt %, excessive carbon can be prevented, in an operationally-safe manner, from binding by carbide formation. There would be a lack of C for forming martensite due to such an excessive binding, such that the proportion of martensite would be reduced after hardening. The hardness and wear resistance would decline accordingly. The V content of a steel according to the invention that is particularly suitable for the purposes according to the invention is thus typically 15.0 wt %.

Niobium is optionally present in contents of up to 2.0 wt % in the steel according to the invention. Nb has a very similar mode of action to vanadium. It is involved in particular in the formation of hard and wear-resistant monocarbides. Nb and V can thus be alternately exchanged in a ratio of 1:1 based on their contents in atom %, when this is found to be expedient for example with respect to the availability of these alloy elements.

Nickel can be optionally present in contents of up to 1.0 wt % in the steel material according to the invention in order to stabilise the austenite proportion similarly to Mn and thus to improve the hardenability. The presence of Ni thus ensures that austenite is actually formed at the respective hardening temperature and no undesired ferrite develops in the structure of the steel. However, an excessive Ni content increases the cooling duration required for the martensite formation. At the same time, there should not be excessive Ni contents present since the danger here is that residual austenite is present in the structure after hardening. Provided Ni is to be added, the Ni content is thus preferably at least 0.2 wt %, optimised effects of the presence of Ni occurring for Ni contents of up to 0.4 wt %.

Cobalt can also optionally be present in contents of up to 1.0 wt % in the steel material according to the invention. Similarly to nickel, Co has a stabilising effect on the austenite formation and the hardening temperature. Unlike nickel or manganese, however, Co does not reduce the end temperature of the martensite, which is why its presence is less critical with respect to the formation of residual austenite. Cobalt also increases the heat resistance. Provided these positive influences are to be utilised by the addition of Co, contents of at least 0.3 wt % Co prove particularly expedient, optimised effects occurring with Co contents of up to 0.5 wt %.

Tungsten can, like Co and Ni, optionally be added to the steel in contents of up to 1.0 wt %. Tungsten primarily increases the temper resistance and is primarily involved in carbide formation when tempering in the secondary hardening maximum. The tempering temperatures are shifted to higher temperatures by the presence of W. Similarly to cobalt, the heat resistance is also increased by W. However, excessive W contents would also stabilise the ferritic phase. Provided the positive influences of W are to be utilised, contents of at least 0.3 wt % W thus prove to be particularly expedient, optimised effects occurring with W contents of up to 0.5 wt %.

The remaining residue of steel consists of iron and unavoidable impurities that enter the steel owing to the production method or the starting materials from which the constituents of the steel alloy powder are obtained, however, have no effect there in relation to the properties.

Sulphur can be present in contents of up to 0.35 wt % in the steel material in order to improve machinability. In the case of higher S contents, the properties of the steel material composed according to the invention are, in contrast, impaired. In order to be able to safely utilise the favourable effect of the presence of S, at least 0.035 wt % can be present in the steel material according to the invention. In contrast, if the machinability is not to be improved by the selective addition of S, the S content can be limited accordingly to less than 0.035 wt %.

Impurities that are unavoidably present also include contents of P of up to 0.035 wt %.

Nitrogen is also not selectively alloyed with the steel material according to the invention, but rather enters the steel material owing to the nitrogen affinity of the alloy constituents during the atomisation process. In order to avoid negative influences of N on the properties of the steel material, the content of N should be less than 0.12 wt %, in particular limited to max. 0.1 wt %.

The density of the steel material according to the invention is typically in the range of 6.6-7.2 g/cm³, it being 7.0-7.2 g/cm³ in the case of the absence of hard material particles and being able to be set to 6.6-7.0 g/cm³ by the addition of hard material particles. Its minimised density and its low weight caused thereby makes the steel according to the invention suitable in particular for the production of such components, which are repeatedly subjected to high acceleration during practical use and in which, as a result thereof, a lower mass inertia has a particularly favourable impact.

The powder-metallurgical production allows the density and wear resistance of steel according to the invention to be further optimised optionally in the sense of the respective application by selective addition of hard phases with low density, provided this is desired with respect to the desired property. It has been shown here that the use properties of the steel according to the invention can be further increased by up to 30 wt % hard material particles being added to it, said hard material particles, in the completely produced steel, being embedded in its steel matrix composed in the manner explained above. The hard materials are present as powder in the starting state like the steel alloy powder forming the steel matrix.

The hard materials, also referred to as “hard phases” in technical language, may be carbides, nitrides, oxides or borides. The group of suitable hard materials therefore includes Al₂O₃, B₄C, SiC, ZrC, VC, NbC, TiC, WC, W₂C, Mo₂C, V₂C, BN, Si₃N₄, NbN or TiN.

TiC has been found to be particularly suitable for the purposes according to the invention. Titanium carbide has a hardness of 3200 HV and thus increases the hardness and wear resistance of the steel particularly effectively. At the same time, TiC is chemically resistant and has no negative influence on corrosion resistance. Likewise, the low density of TiC has an advantageous effect.

In order to utilise the advantageous presence of the hard material particles, at least 2.5 wt %, in particular at least 5.0 wt % hard material particles may be present in the steel material according to the invention. Hard material contents of up to 25 wt % prove to be particularly favourable with respect to the desired properties. The contents of hard material particles in a steel material according to the invention mentioned here prove expedient in particular when the hard material is titanium carbide TiC.

The steel according to the invention reaches hardness values of at least 60 HRC after hardening and tempering even without the presence of hard materials, typical hardness values being in the range of 62-65 HRC.

The hardness can be further increased in the presence of hard material particles in the steel according to the invention. It is then typically in the range of 63-68 HRC.

A steel according to the invention that has particularly proven its value during practical tests and that has the alloy constituents mentioned above as typical for said steel, has, for example a density of 7.1 g/cm³ and a hardness of 63 HRC without the addition of hard material particles, whereas its density is 6.9 g/cm³ in the presence of hard material particles and its hardness has 65 HRC.

After soft annealing generally carried out for mechanical processing, the typical soft annealing hardness of steel material according to the invention that does not contain hard material particles is 43-53 HRC, whereas its soft annealing hardness in the presence of hard material particles is typically 46-55 HRC.

At least the following work steps are performed for producing components according to the invention made of steel according to the invention:

a) A steel alloy powder is provided that consists (in wt %) of 3.9-5.0% C, 0.3-2.0% Si, 0.3-2.0% Mn, <0.035% P, <0.35% S, <0.12% N, 12.0-15.0% Cr, 0.5-2.0% Mo, 13.5-16.5% V, optionally one element or a plurality of elements from the group “Nb, Ni, Co, W”, wherein the content of elements “Ni, Co, W” is at most 1.0% and the content of Nb is at most 2.0% and the residue consists of iron and unavoidable impurities.

b) The steel alloy powder is optionally mixed with hard material particles subject to the condition that the hard material particle content of the steel alloy powder/hard material particle mixture obtained is up to 30 wt %.

c) The steel alloy powder or the steel alloy powder/hard material mixture is optionally dried.

d) A solid semi-finished product is formed from the steel alloy powder or the steel alloy powder/hard material mixture by a sintering process, in particular by hot isostatic pressing or by an additive process.

e) The semi-finished product obtained is finished to form the component.

The following indications apply in relation to the practical performance and the configurations of the work steps a) to e) of the method according to the invention:

Work step a)

The powder production can take place conventionally for example by gas atomising or any other suitable method. To this end, the alloy powder can for example be produced by gas or water atomising or a combination of these two atomising processes. Atomising a melt alloyed in the manner according to the invention into the alloy powder is conceivable.

However, it is also alternatively possible to firstly provide the alloy elements of the steel alloy powder individually in powder form in quantities that correspond to the content proportions provided for the respective alloy element and to then mix these powder quantities into the steel alloy powder composed according to the invention.

If required, powder particles are selected by sieving from the powder particles for further processing according to the invention, said powder particles having an average diameter of less than 500 μm, powders with average grain sizes of less than 250 μm, in particular of less than 180 μm having proven to be particularly suitable.

Irrespective of the manner of its production, the alloy powder provided according to the invention optimally has a bulk density of 2-6 g/cm³ (determined according to DIN EN ISO 3923-1) and a tap density of 3-8 g/cm³ (determined according to DIN EN ISO 3953).

Work step b)

Insofar as this is provided, the steel alloy powder produced in work step a) is mixed with the hard material powder selected. The quantity of mixed hard material particles is determined taking into account the indications previously given in relation to the optimised selection of the content of hard materials.

Work step c)

If required, the alloy powder obtained in work step a) and the optionally performed work step b) can be conventionally dried in order to remove residues of fluids and other volatile constituents that could hinder the subsequent forming process.

Work step d)

A blank (semi-finished product) is now formed from the alloy powder optionally containing hard material particles. To this end, the alloy powder or the alloy powder in a manner known per se can be brought into the respective form by a suitable sintering process, in particular by hot isostatic pressing (“HIP”). In general, HIP is carried out. Typical pressures during HIP are in the range of 900-1500, in particular 1000 bar, at a temperature of 1050-1250° C., in particular 1080-1200° C. During the course of hardening, austenite, VC and Cr carbide are formed in the structure of the steel material.

Alternatively, the respective component can also be produced in an additive process from the alloy powder obtained and provided according to the invention. The term “additive” encompasses all manufacturing methods in which a material is added to produce a component, this adding generally taking place in layers. “Additive manufacturing processes”, which are often also referred to in technical language as “generative processes”, thus contrast with the classic subtractive production processes such as machining processes (e.g. milling, drilling and rotating), in which material is removed in order to give the component to be produced its form. The additive construction principle allows geometrically complex structures to be produced that cannot be implemented or can only implemented with difficulty using conventional manufacturing processes such as the aforementioned machining processes or primary shaping processes (casting, forging) (see VDI Status Report “Additive Fertigungsverfahren”, September 2014, issued by the Verein Deutscher Ingenieure e.V. (Association of German Engineers), specialist field of production technology and manufacturing processes, www.vdi.de/statusadditiv). Further definitions of the processes, which are compiled under the general term of “additive processes” can be found for example in the VDI Standards 3404 and 3405.

Work step e)

The semi-finished product obtained according to work step d) still requires finishing in order to give it, on the one hand, the desired use properties and, on the other hand, the required final form. The finishing comprises, for example, mechanical processing, in particular machining of the semi-finished product and a heat treatment that can consist of hardening and tempering.

The invention is explained further below based on exemplary embodiments:

Alloy powders composed according to the invention in the manner previously explained are formed into a blank (semi-finished product) for example by hot isostatic pressing or another suitable sintering process. To this end, the respective alloy powder can be filled into a suitable mould, for example a cylindrical capsule and can then be held at typical pressures of 900-1500 bar (90-150 MPa), in particular 1000 bar (100 MPa), at a temperature of 1050-1250° C., in particular 1150° C. for a sufficient duration until a solid body results. The pressure for hot isostatic pressing is typically in the range of 102-106.7 MPa and the heating to the target temperature of typically 1150-1153° C., which is held for a duration of typically 200-300 min, in particular 245 min, also typically takes place at a heating rate of 3 K/min-10 K/min.

The heat treatment follows the production of the semi-finished product. The respective semi-finished product is heated at a heating speed of typically 5 K/min to a hardening temperature (austenitisation temperature) of 1080-1200° C., typically 1125° C., at which it is held until it is fully heated throughout. The time required for this is typically 30-60 mins. Semi-finished products heated in this manner are then quenched. In doing so, they are cooled with a suitable quenching medium, for example with water, oil, a polymer bath, moving or stationary air or, if the cooling is carried out in a vacuum furnace, with gaseous nitrogen, within 5-30 mins to room temperature. In particular in the case of large semi-finished products, it may be expedient to carry out the heating to the hardening temperature in a plurality of pre-heating stages, e.g. 400° C., 600° C. and 800° C. or a pre-heating temperature in the range of 600-800° C. in order to ensure uniform heating throughout.

In order to avoid reactions with the ambient atmosphere, the hardening may be carried out in a vacuum furnace in a manner also known per se. However, this is not a requirement for the success of the approach according to the invention.

After hardening, tempering may be carried out in which the semi-finished product is held for a duration of for example 90 min at the respective tempering temperature of typically 490-510° C. The tempering conditions are selected in a manner known per se as a function of the respective hardening temperature and the desired hardening level, that is, the desired strength. The heating and cooling speeds are generally in the magnitude of 10 K/min during tempering. Unlike hardening, the heating and cooling speeds are not critical for tempering. The brittle martensite loosens by means of the tempering through the diffusion of carbon. Said martensite, together with, for example, V, Cr and Mo, forms the so-called “temper carbides”. The toughness increases as a result. At the same time, the strength and hardness of the steel material decreases only slightly since these properties are again increased by the carbide formation.

Since there is generally a narrow temperature range (approx. 50° C. roughly between 450 and 650° C.) for such alloying systems, the term secondary hardening maximum is used since temperatures above and below this denote a lower hardness.

The following tests were carried out using the general approach explained above for the practical production of steel materials according to the invention and components produced therefrom:

For the production of sample components, two alloys V15 and V15_MMC according to the invention were produced, whose compositions are indicated in Table 1. The steel material V15 thus contains no hard material particles, whereas additionally 5 wt % TiC hard material particles are contained in the steel material V15_MMC in a steel matrix composed identically to the steel material V15.

The steel materials V15 and V15_MMC were produced via powder metallurgy.

To this end, steel alloy powders with the composition indicated in Table 1 for the steel material V15 were produced by atomising in the manner already explained above and known per se. The average diameter of the particles of the alloy powders was less than 250 μm.

In the steel material V15_MMC, the alloy powder produced for the steel material V15 is then additionally mixed with the TiC hard material particles also present in powder form and corresponding to a smaller particle size.

The correspondingly composed V15 and V15_MMC alloy powders were solidified by hot isostatic pressing into cylindrical bodies. To this end, the respective alloy powder was filled into cylindrical capsules. The powder filled into the capsules was then heated at a heating rate of 3-10 K/min and at pressures of 102-106.7 MPa to a target temperature of 1150-1153° C., at which they were each held for a hold time of 245 mins. After the end of the hold time, the solid cylindrical pieces obtained as the semi-finished product were cooled at a cooling speed of 3-10 K/min to room temperature.

Two semi-finished product samples V15a and V15b consisting of the steel material V15 and two semi-finished product samples V15_MMC_a and V15_MMC_b consisting of the steel material V15_MMC were subjected to a heat treatment whose parameters are indicated in Table 2.

In this case, the samples V15_a and V15_MMC_a were heated at a heating speed of approx. 5 K/min in a vacuum furnace to a hardening temperature (austenitisation temperature) AT at which they were held for a hold duration of respectively 60 mins.

After the hold duration, the samples V15_a and V15_MMC_a still had to be quenched in a vacuum furnace with gaseous nitrogen that was applied at 3.5 bar.

In order to test the influence of a tempering treatment on the hardness, the hardness HRC (“HRC_v”) present prior to the tempering was determined on the samples V15_a and V15_MMC_a hardened in this manner. The average values of said hardness are indicated in Table 2.

The samples V15_a and V15_MMC_a were then subjected to a tempering treatment. To this end, they were heated at a heating rate of respectively approx. 10 K/min to a tempering temperature ST at which they were held for a duration of St before they were cooled at a cooling rate of likewise approx. 10 K/min back to room temperature. This tempering treatment was then repeated once to obtain optimal tempering results.

The samples V15_b and V15_MMC_b were, in contrast, subjected to soft annealing, in which they were heated to a soft annealing temperature of 900° C. at 10 K/min, at which temperature they were held for 8 hours. A slow cooling to room temperature then took place in the switched-off furnace.

The hardness HRC (“HRC_n”) present after tempering was determined on the samples V15_a, V15_b and V15_MMC_a and V15_MMC_b tempered or soft annealed in this manner. The average values of said hardness are also indicated in Table 2.

The density ρ of the samples consisting of the steel material V15 was on average 7.1 g/cm³, whereas it was 6.9 g/cm³ for the samples consisting of the steel material V15_MMC.

In Image 1, an image of a microsection of the sample consisting of the steel material V15_MMC obtained with an electron microscope is reproduced. This shows clearly pronounced vanadium carbides (medium grey) that result from the C and V contents and are embedded in a uniformly distributed manner in the steel matrix in combination with the titanium carbides (dark grey) added separately and the Cr carbides (light grey) resulting likewise from the alloy and heat treatment.

In the alloys V15 and V15_MMC, the hardness can be set by varying the V and C contents.

For a softer variant V14 and V14_MMC, the C content was respectively set in the range of 4.0-4.4 wt % and the V content was set in the range of 13.5-14.5 wt % are also set. The semi-finished products produced via powder metallurgy in the manner explained above for the examples V15_a and V15_MMC_a from the variant V14 and the variant V14_MMC had a hardness on average of 66.0 HRC (variant V14) and 67 HRC (variant V14_MMC) after a hardening carried out in the manner also already explained above for the examples V15_a and V15_MMC_a (austenitisation at 1125° C. for 60 mins; quenching with N₂ gas pressurised at 3.5 bar). After a tempering treatment carried out in the manner also already explained above for the examples V15_a and V15_MMC_a (tempering at 500° C. for 90 mins, repeated once), the semi-finished products consisting of the variants V14 and V14_MMC then had a hardness on average of 62.5 HRC (variant V14) and 64.5 HRC (variant V14_MMC).

Furthermore, semi-finished product samples produced via powder metallurgy in the manner explained above from the variants V14 and V14_MMC were subjected to soft annealing for 8 hours at 500° C. On average, the hardness was 44 HRC (variant V14) and 46 HRC (variant V14_MMC) after the soft annealing.

For a harder variant V16 and V16_MMC, the C content was respectively set in the range of 4.5-4.9 wt % and the V content was set in the range of 15.5-16.5 wt %. Semi-finished products produced via powder metallurgy in the manner explained above for the examples V15_a and V15_MMC_a from the variant V16 and the variant V16_MMC had a hardness on average of 69.0 HRC (variant V16) and 69.5 HRC (variant V16_MMC) after a hardening carried out in the manner already explained above for the examples V15_a and V15_MMC_a (austenitisation at 1125° C. for 60 mins; quenching with N₂ gas pressurised at 3.5 bar). After a tempering treatment carried out in the manner also already explained above for the examples V15_a and V15_MMC_a (tempering at 500° C. for 90 mins, repeated once), the semi-finished products consisting of the variants V16 and V16_MMC then had a hardness on average of 65.5 HRC (variant V16) and 66.5 HRC (variant V16_MMC).

Lastly, semi-finished product samples produced via powder metallurgy in the manner explained above from the variants V16 and V16_MMC were also subjected to soft annealing for 8 hours at 500° C. On average, the hardness after the soft annealing was 47.5 HRC (variant V16) and 52.0 HRC (variant V16_MMC).

The invention thus provides a steel material that offers a combination of properties that is optimised for the production of components that are subjected to high mechanical, corrosive, thermal and abrasive stresses during practical use. To this end, the steel material according to the invention is produced via powder metallurgy and consists of (in wt %) C: 3.9-5.0%, Si: 0.3-2.0%, Mn: 0.3-2.0%, P: 0-<0.035%, S: 0-<0.35%, N: 0-<0.12%, Cr: 11.0-15.0%, Mo: 0.5-2.0%, V: 13.5-16.5%, optionally one element or a plurality of elements from the group “Nb, Ni, Co, W”, wherein the content of elements “Ni, Co, W” respectively is at most 1.0% and the content of Nb is at most 2.0% and contains a residue of iron and unavoidable impurities, wherein hard material particles may be present in contents of up to 30 wt % in the steel matrix composed in this manner. A solid semi-finished product is formed by a sintering process or an additive process from a steel alloy powder alloyed in this manner, said solid semi-finished product then being finished to form the respective component.

TABLE 1

| | C | Si | Mn | Cr | Mo | V | TiC |
|---|---|---|---|---|---|---|---|
| Steel | [wt %] | | | | | | |
| V15 | 4.5 | 1.2 | 1.2 | 13.0 | 1.2 | 15.0 | — |
| V15_MMC | 4.5 | 1.2 | 1.2 | 13.0 | 1.2 | 15.0 | 5.0 |

*) residual iron and unavoidable impurities

TABLE 2

| | AT | HRC_v | ST | St | HRC_n |
|---|---|---|---|---|---|
| Sample | [° C.] | average | [° C.] | [min] | average |
| V15_a | 1125 | 68.0 | 500 | 2 × 90 | 64.0 |
| V15_b | — | — | ¹⁾ | ¹⁾ | 46.5 |
| V15_MMC_a | 1125 | 68.5 | 500 | 2 × 90 | 65.5 |
| V15_MMC_b | — | — | ¹⁾ | ¹⁾ | 49.0 |

¹⁾ Soft annealing (see text)

1. A steel material that is produced via powder metallurgy and comprises a matrix comprising (in wt %):

| | |
|---|---|
| C: | 3.9-5.0%, |
| Si: | 0.3-2.0%, |
| Mn: | 0.3-2.0%, |
| P: | 0-<0.035%, |
| S: | 0-<0.35%, |
| N: | 0-<0.12%, |
| Cr: | 11.0-15.0%, |
| Mo: | 0.5-2.0%, |
| V: | 13.5-16.5%, and |

the remainder being iron and unavoidable impurities,
wherein hard material particles are present in contents of up to 30 wt % in the steel matrix.

2. The steel material according to claim 1, wherein the C content is at least 4.2 wt % and at most 4.6 wt %.

3. The steel material according to claim 1, wherein the Si content is at least 0.7 wt % and at most 1.5 wt %.

4. The steel material according to claim 1, wherein the Mn content is at least 0.7 wt % and at most 1.5 wt %.

5. The steel material according to claim 1, wherein the S content is at least 0.035 wt %.

6. The steel material according to claim 1, wherein the Cr content is at least 12.5 wt % and at most 13.5 wt %.

7. The steel material according to claim 1, wherein the Mo content is at least 0.9 wt % and at most 1.5 wt %.

8. The steel material according to claim 1, wherein the V content is at least 14.5 wt % at most 15.5 wt %.

9. The steel material according to claim 1, wherein the matrix further comprises (in wt. %) at least one element selected from the group consisting of:

| | |
|---|---|
| Ni: | 0.2-0.4%, |
| Co: | 0.3-0.5%, and |
| W: | 0.3-0.5%, |

10. The steel material according to claim 1, wherein the content of hard material particles is at least 2.5 wt %.

11. The steel material according to claim 1, where the hard material particles have an average grain size of at most 50 μm.

12. A method for producing a component that consists of a steel material according to claim 1, comprising the following work steps:
providing a steel alloy powder comprising (in wt %) 3.9-5.0% C, 0.3-2.0% Si, 0.3-2.0% Mn, <0.035% P, <0.35% S, <0.12% N, 11.0-15.0% Cr, 0.5-2.0% Mo, 13.5-16.5% V, and the remainder being iron and unavoidable impurities;
optionally, mixing the steel alloy powder with hard material particles to produce a steel alloy power/hard material particle mixture, wherein the hard material particle content of the steel alloy powder/hard material particle mixture is up to 30 wt %;
optionally, drying the steel alloy powder or the steel alloy powder/hard material mixture;
forming a solid semi-finished product from the steel alloy powder or the steel alloy powder/hard material mixture by a sintering process or by an additive process; and
finishing the semi-finished product to form the component.

13. The method according to claim 12, wherein the elements of the steel alloy powder are provided individually in powder form and are mixed to form the steel alloy powder.

14. The method according to claim 12, wherein finishing the semi-finished product comprises machining the semi-finished product.

15. A component that performs movements with high acceleration or speed during practical use, produced from a steel material according to claim 1.

16. The steel material according to claim 1, wherein the matrix further comprises at least one element selected from the group consisting of Nb, Ni, Co, and W, wherein the content of each of Ni, Co, and W is at most 1.0% and the content of Nb is at most 2.0%.

17. The method of claim 12, wherein the steel alloy powder optionally includes one at least one element selected from the group consisting of Nb, Ni, Co, and W, wherein the content of each of Ni, Co, and W is at most 1.0% and the content of Nb is at most 2.0%.

18. The method of claim 12, wherein the sintering process is hot isoslatic pressing.
